(19) United States
(12) Patent Application Publication
(10) Pub. No.: US 2026/0229169 A1
(43) Pub. Date: Aug. 6, 2026

(54) GLOBAL SCANNING METHOD WITH OFFSET AND MICRO-DISPLAY SYSTEM

(71) Applicant: Hue Inc., Shanghai (CN)

(72) Inventors: Chunming Li, Shanghai (CN); Jing Shao, Shanghai (CN); Jing Ju, Shanghai (CN); Hongyun Liu, Shanghai (CN)

(73) Assignee: Hue Inc., Shanghai (CN)

(21) Appl. No.: 19/530,364

(22) Filed: Feb. 5, 2026

(30) Foreign Application Priority Data
Feb. 6, 2025 (CN) 202510133505.3

(51) Int. Cl. G09G 3/32

(52) U.S. Cl. CPC G09G 3/32; G09G 2310/08; G09G 2320/0233

(57) ABSTRACT

The present disclosure relates to a global scanning method with offset and a micro-display system, and the global scanning method with offset includes: dividing multiple rows of micro-LEDs of at least one micro-display panel into a plurality of display groups, each display group including one or more rows of micro-LEDs; determining a scanning offset duration between adjacent display groups; and scanning sequentially the plurality of display groups of the at least one micro-display panel according to the scanning offset duration. Using the global scanning method with offset of the present disclosure, the number of micro-LEDs illuminated simultaneously is reduced, and the distribution of current is more uniform in time and space, thus local concentration of peak current is avoided, and the voltage drop generated during scanning is reduced, so that the service life of the micro-display panel can be improved and the stability of the display system is improved.

### CROSS-REFERENCE TO RELATED APPLICATION

This application claims the priority benefit of Chinese patent application No. 202510133505.3, filed on Feb. 6, 2025. The entirety of the above-mentioned patent application is hereby incorporated by reference herein and made a part of this specification.

### BACKGROUND

### Technical Field

The present disclosure relates to the field of micro-LED technology, and particularly relates to a global scanning method with offset and a micro-display system.

### Description of Related Art

Micro light emitting diode (Micro-LED) is an emerging display technology, which miniaturizes traditional LED to make its size to micrometer-level, and as small-sized and luminescent semiconductor components, micro-LED devices have advantages such as low power consumption, long lifespan, high brightness, and high contrast ratio, etc.

Currently, micro-LEDs are limited by process conditions and color panels cannot be mass produced. The existing micro-display panels composed of micro-LED arrays are typically monochromatic, i.e., which can only emit light of one color. If it is needed to display color images, three micro-display panels capable of emitting different colors of light need to be assembled together for use, i.e., a red micro-display panel, a green micro-display panel, and a blue micro-display panel are assembled to form a micro-display system.

When displaying color images, pulse width modulation (PWM) technology is used to control the turning-on of relevant micro-LEDs for display. The current turning-on method is full-screen turning-on to scan all rows at the same time, i.e., the relevant micro-LEDs in each row of the micro-LED array will be turned on at the same time, and will be turned off simultaneously at the end of the scan, this turning-on method will cause serious voltage drop, thereby reducing the service life of the micro-display panel.

### SUMMARY

In order to solve at least some of the aforementioned issues in the prior art, the task of the present disclosure is to provide a global scanning method with offset, which includes:

dividing multiple rows of micro-LEDs of at least one micro-display panel into a plurality of display groups, and each of the plurality of display groups comprising one or more rows of micro-LEDs;

determining the scanning offset duration between display groups adjacent in terms of scanning time; and

scanning sequentially the plurality of display groups of the at least one micro-display panel according to the scanning offset duration.

Furthermore, one or more rows of micro-LEDs scanned using the same group of scanning signals are divided into a display group.

Furthermore, each display group includes multiple rows of micro-LEDs, and the multiple rows of micro-LEDs are adjacent or not adjacent in positions.

Furthermore, the scanning offset duration between display groups adjacent in terms of scanning time is determined according to the scanning period, a number of display groups, and a duty cycle of a frame of image data.

Furthermore, the scanning period T, and the number of display groups M, the scanning offset duration t, and the duty cycle D of a frame of image data satisfy the following relationship:

T≥(D*T)+t*(M−1),

and M is a positive integer, t, T, and D are positive numbers, and the scanning offset duration t and the duty cycle D are fixed values.

Furthermore, the larger the duty cycle, the greater the number of display groups, the smaller the maximum value of the scanning offset duration.

Furthermore, the duty cycle D is less than 1.

Furthermore, the scanning duration of each display group is the same.

Furthermore, an interval between scanning start time points of two display groups adjacent in terms of scanning time equals the scanning offset duration.

Furthermore, scanning sequentially the plurality of display groups of the at least one micro-display panel according to the scanning offset duration includes:

first scanning a first display group, then scanning a second display group after a first scanning offset duration, and so on, scanning the M-th display group after the (M−1)-th scanning offset duration, where M is a number of the plurality of display groups, and M is a positive integer.

Furthermore, a group of scanning signals includes multiple bits of data.

Furthermore, during scanning, a group of scanning signals is transmitted by a plurality of signal lines.

Furthermore, each signal line transmits one bit of data.

Furthermore, under a case that a display group includes multiple rows of micro-LEDs, the group of scanning signals includes a plurality of sub-signal groups, and each sub-signal group includes multiple bits of data.

Furthermore, under a case that a display group includes one row of micro-LEDs, during scanning, an interval exists between the transmission start time points of two bits of data adjacent in transmission times.

Furthermore, under a case that a display group includes multiple rows of micro-LEDs, during scanning, an interval exists between the transmission start time points of two bits of data adjacent in transmission times in each sub-signal group.

Furthermore, the interval between the transmission start time points of two bits of data adjacent in transmission times equals the pulse length during the transmission of the previous bit of data.

Furthermore, the pulse length of each bit of data increases sequentially.

Furthermore, the at least one micro-display panel includes a plurality of micro-display panels, each micro-display panel including a plurality of display groups.

The present disclosure also provides a micro-display system, which includes:
one or more micro-display panels; and
a controller configured to execute the global scanning method with offset.

Furthermore, the micro-display panel includes:
a micro-LED chip configured to emit light; and
a circuit board electrically connected with the micro-LED chip.

Furthermore, the micro-LED chip includes:
a drive backplane; and
a plurality of micro-LEDs arranged in an array on the drive backplane.

Furthermore, the micro-LED includes:
an epitaxial layer;
a top conductive layer, the top conductive layer is located on the side surface and top surface of the epitaxial layer; and
a passivation isolation layer, the passivation isolation layer at least partially covers the side surface of the epitaxial layer, and the passivation isolation layer is located between the epitaxial layer and the top conductive layer.

Furthermore, the drive backplane includes:
a substrate;
a drive circuit located in the substrate and configured to control the turning-on and -off of the micro-LEDs;
drive electrodes electrically connected with the drive circuit and the micro-LED chip.

Furthermore, the micro-LEDs are located on the drive electrodes, and each micro-LED corresponds to a drive electrode.

Furthermore, the micro-LED chip further includes: a current expansion structure located between the micro-LEDs, and the current expansion structure is arranged to surround the micro-LEDs, and the current expansion structure is configured to electrically contact the micro-LEDs and at least partially reflect light emitted by the micro-LEDs.

Furthermore, the micro-LED chip further includes microlenses, which are arranged above the micro-LEDs, and adjacent microlenses are interconnected.

The present disclosure has at least the following beneficial effects:
(1) By using the global scanning method with offset of the present disclosure to scan the micro-LEDs of a micro-display panel, the number of micro-LEDs turned on at the same time can be reduced, and the distribution of current is more uniform in time and space, thus local concentration of peak current is avoided, and meanwhile, the voltage drop generated during scanning is reduced, so that the service life of the micro-display panel can be improved and the stability of the display system is improved.
(2) By using the global scanning method with offset to scan a plurality of micro-display panels, it is more conducive to mixing different colors and reducing color separation phenomena.

### BRIEF DESCRIPTION OF THE DRAWINGS

In order to further explain the above and other advantages and features of various embodiments of the present disclosure, a more specific description of various embodiments of the present disclosure will be provided with reference to the accompanying drawings. It can be appreciated that these accompanying drawings depict only typical embodiments of the present disclosure, and therefore will not be construed as limiting their scope. In the accompanying drawings, identical or corresponding parts will be indicated by the same or similar reference numerals for the sake of clarity.

FIG. 1 illustrates a schematic diagram of row scanning turning-on of an existing micro-display panel.

FIG. 2 illustrates a schematic diagram of full-screen turning-on of an existing micro-display panel.

FIG. 3 illustrates a flowchart schematic diagram of a global scanning method with offset according to an embodiment of the present disclosure.

FIG. 4 illustrates a schematic diagram of a global scanning method with offset according to an embodiment of the present disclosure.

FIG. 5 illustrates a schematic diagram of a global scanning method with offset having different duty cycles according to an embodiment of the present disclosure.

FIG. 6 illustrates a timing schematic diagram of a global scanning method with offset according to an embodiment of the present disclosure.

### DESCRIPTION OF THE EMBODIMENTS

It should be noted that various components in the accompanying drawings may be exaggerated for the purpose of illustrative illustration and are not necessarily true to scale.

In the present disclosure, the embodiments are merely intended to illustrate the scheme of the present disclosure and should not be construed as limiting.

In the present disclosure, the quantifiers “a” and “one” do not exclude scenarios with multiple elements, unless otherwise specified.

It should also be noted herein that in embodiments of the present disclosure, only a portion of the components or assemblies may be shown for the sake of clarity and simplicity, but those ordinary skilled in the art will be able to understand that the required components or assemblies may be added as needed according to specific scenarios in light of the teachings of the present disclosure.

It should also be noted that, within the scope of the present disclosure, the terms “the same”, “equal”, “equal to”, etc. do not mean that the two numerical values are absolutely equal, but rather allow for a certain reasonable error, that is to say, the terms also cover “substantially the same”, “substantially equal” and “substantially equal to”.

It should also be noted herein that in the description of the present disclosure, orientations or positional relationships indicated by terms such as “center”, “longitudinal”, “transverse”, “up”, “down”, “front”, “rear”, “left”, “right”, “vertical”, “horizontal”, “top”, “bottom”, “inner”, “outer”, etc., are based on the orientations or positional relationships shown in the accompanying drawings, these terms are only for the purpose of facilitating the description of the present disclosure and simplifying the description, rather than explicitly or implicitly indicating that the devices or elements referred to must have a specific orientation, be constructed in a specific orientation, or operate in a specific orientation, therefore, they should not be construed as limitations on the present disclosure. Furthermore, the terms “first” and “second” are used only for descriptive purposes and should not be construed as explicitly or implicitly indicating relative importance.

Furthermore, the embodiments of the present disclosure describe the process steps in a specific order, however, this is only for the purpose of illustrating the specific embodiment, rather than limiting the order of the steps, and in different embodiments of the present disclosure, the order of the steps can be modified according to the adjustment of the process.

In the present disclosure, the term “configure” refers to the setting of the shape, structure, material, and/or function of a target object to achieve a desired technical effect, and “configure” includes various alternative technical means to achieve this technical effect, and these technical means become apparent under the teachings of the present disclosure.

In the present application, the term “pixel row scanning” refers to turning-on or controlling the brightness of one or more pixels in a corresponding pixel row in the image according to the display signal, that is to say, pixel row scanning is to output the corresponding display signal to that pixel row, but does not necessarily turn on all pixels in that row.

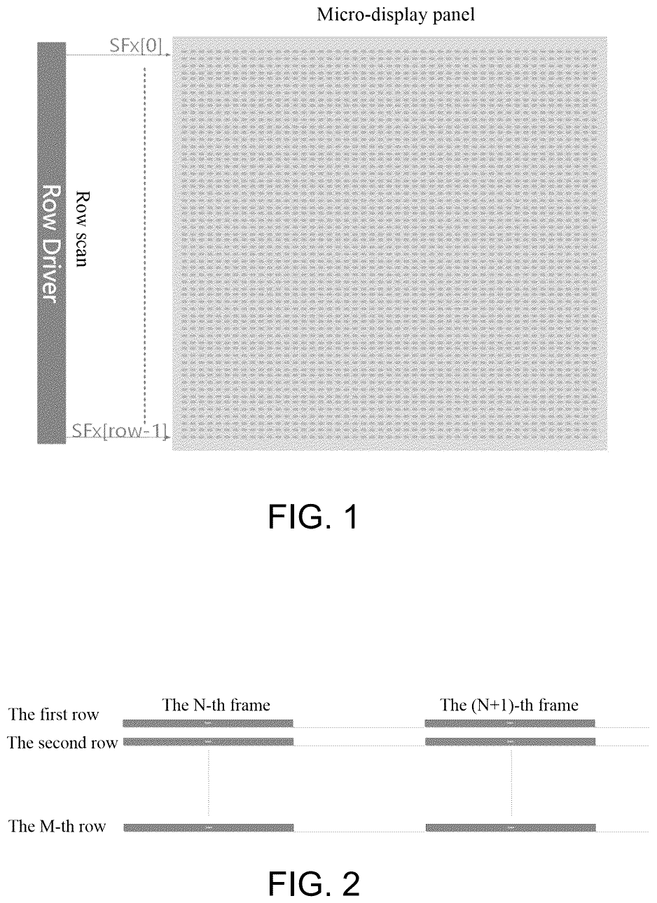

FIG. 1 illustrates a schematic diagram of row scanning turning-on of an existing micro-display panel. FIG. 2 illustrates a schematic diagram of full-screen turning-on of an existing micro-display panel.

As shown in FIG. 1, the micro-display panel includes multiple rows of micro-LEDs arranged in an array, and each row includes a plurality of micro-LEDs arranged in order. When displaying images, the micro-LEDs of the micro-display panel are turned on using a row-scanning method. The “row” in the figure represents the total number of rows in the micro-display panel. The scanning signals SFx[0]-SFx[row−1] are primarily used to control row scanning of the micro-display panel to selectively turn on micro-LEDs to display images. The scanning signal SFx[0] is used to control the scanning of the first row, SFx[1] is used to control the scanning of the second row, and so on, SFx [row−1] is used to control the scanning of the row-th row.

As shown in FIG. 2, currently, the display of the micro-display panel requires PWM control to turn on relevant pixels, when displaying, the micro-LEDs of the micro-display panel are turned on using a full-screen turning-on method. The scan signals SFx[0]-SFx[row−1] simultaneously control all rows of the micro-display panel to scan, and the relevant micro-LEDs in each row of the micro-LED array are turned on simultaneously, and be turned off simultaneously at the end of the scan. During the scanning process, a large number of micro-LEDs are turned on simultaneously, which will cause current concentration, and when they are turned off, the current suddenly decreases and the voltage drops suddenly, resulting in a significant voltage drop, which will reduce the service life of the micro-display panel. Furthermore, the full-screen turning-on method is prone to cause color separation during color display. When displaying color images, all three micro-display panels are scanned simultaneously, but the pixels (micro-LEDs) of each micro-display panel are different, and the grayscale values are different, and the internal system frequency may also be different. Differences in the luminous characteristics of the three-color LEDs (red, green, blue), such as response time and luminous efficiency, etc., are different, which may cause them to not reach the optimal color mixing state at the same moment, resulting in uneven color mixing and color separation.

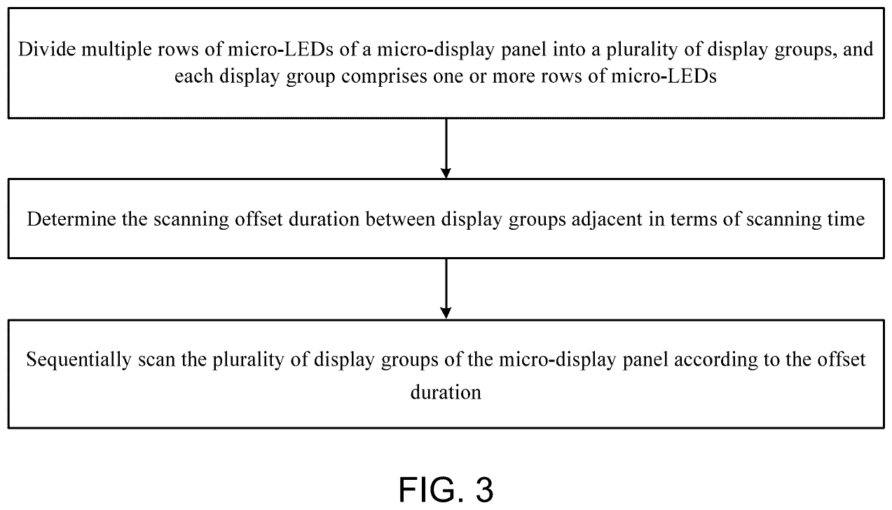

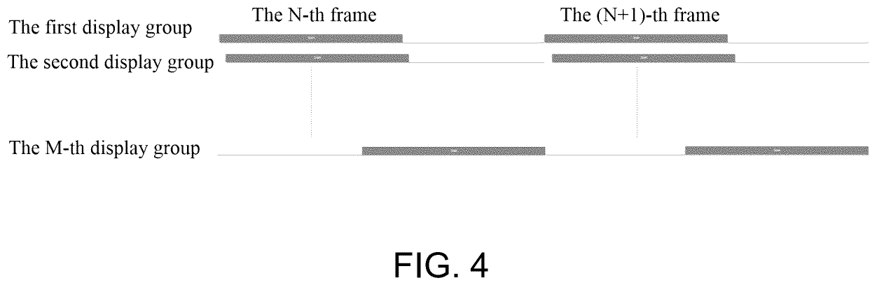

FIG. 3 illustrates a flowchart schematic diagram of a global scanning method with offset according to an embodiment of the present disclosure. FIG. 4 illustrates a schematic diagram of a global scanning method with offset according to an embodiment of the present disclosure.

As shown in FIG. 3, a global scanning method with offset includes:
Step 1: Dividing multiple rows of micro-LEDs of a micro-display panel into a plurality of display groups, each display group includes one or more rows of micro-LEDs.
Step 2: Determining the scanning offset duration between display groups adjacent in terms of scanning time.
Step 3: As shown in FIG. 4, sequentially scanning the plurality of display groups of the micro-display panel according to the scanning offset duration. The interval between the scanning start time points of two adjacent display groups equals the scanning offset duration. First, the first display group is scanned, then the second display group is scanned after the first scanning offset duration, and so on, the M-th display group is scanned after the (M−1)-th scanning offset duration, all display groups are completely scanned in the scanning period of a frame of image data.

The number of micro-display panels is multiple, preferably 3, and each micro-display panel includes a plurality of display groups. The multiple micro-display panels are scanned simultaneously using a global scanning method with offset.

The global scanning method with offset is described in detail below.

In some embodiments, one or more rows of micro-LEDs scanned using the same group of scanning signals are divided into a display group. In some embodiments, each display group includes multiple rows of micro-LEDs, such as 2 rows, 3 rows, or 4 rows, etc., and the multiple rows of micro-LEDs are adjacent or not adjacent in position.

In some embodiments, during scanning, a group of scanning signals is used to scan a display group, meanwhile, one or more rows of micro-LEDs within a display group are scanned.

In some embodiments, the scanning duration for each display group is the same.

In some embodiments, the scanning offset duration is determined according to the scanning period, the number of display groups, and the duty cycle of a frame of image data. The scanning period T, and the number of display groups M, the scanning offset duration t, and the duty cycle D of a frame of image data satisfy the following relationship:

T≥(D*T)+t*(M−1),
and M is a positive integer, t, T, and D are positive numbers, and the scanning offset duration t and the duty cycle D are fixed values.

The duty cycle is related to brightness: the higher the duty cycle, the longer scanning time for each display group, and the longer turning-on time for the micro-LEDs, and the greater the brightness. The scanning period for a frame of image data is fixed, all display groups of the micro-display panel need to be scanned within the scanning period, the larger the duty cycle, the more display groups there are, and the maximum of the scanning offset duration is smaller. Conversely, the smaller the duty cycle, the larger the maximum of the scanning offset duration, and the wider the selectable range of scanning offset durations.

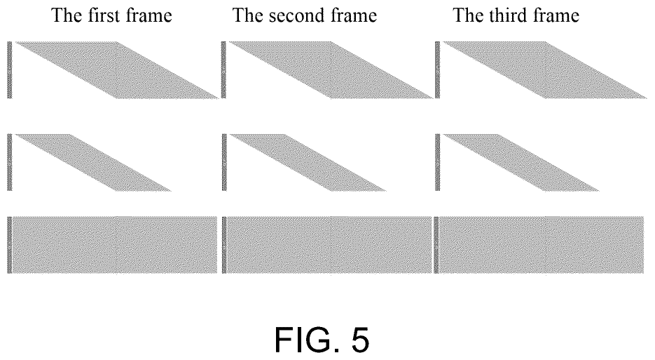

FIG. 5 illustrates a schematic diagram of a global scanning method with offset having different duty cycles according to an embodiment of the present disclosure.

In the first row of FIG. 5, the duty cycle D=½, the scanning offset duration is set to the maximum value, and the total scanning duration for all display groups equals the scanning period of a frame of image data.

In the second row of FIG. 5, the duty cycle D=¼, the scanning offset duration is the same as the scanning offset duration of the first row, and the total scan duration for all display groups is less than the scanning period of a frame of image data.

In the third row of FIG. 5, the duty cycle D=1, and the scanning duration for each display group equals the scanning period of a frame of image data; at this time, all display groups start scanning simultaneously, and there is no scanning offset duration between display groups, which belongs to a full-screen turning-on scanning method.

In some embodiments, as shown in FIG. 5, the micro-display panel loads display data before scanning a frame of image data. The display period of a frame of image includes at least the time for loading display data and the scanning period for a frame of image data. Typically, the display period of a frame of image is fixed, and when the total scanning duration of all display groups is small, there is idle time after the scanning is completed and before loading the display data. The display period of a frame of image also includes idle time.

In some embodiments, a group of scanning signals can describe characteristics such as the brightness and turning-on sequence, etc., of the micro-LEDs (pixels) of a display group. A group of scanning signals includes 10 bits of data transmitted by 10 signal lines (sf0-sfx), and each signal line transmits 1 bit of data. 10 bits of data can describe characteristics such as the brightness and turning-on sequence, etc., of pixels of a display group. 10 signal lines entirely serve as a group to transmit data sequentially according to a specific timing sequence to achieve row scanning.

During scanning, there is an interval between the transmission start time points of two bits of data adjacent in transmission times in a group of scanning signals corresponding to a display group, this interval equals the pulse length during the transmission of the previous bit of data

In some embodiments, a display group includes a row of micro-LEDs, and a group of scanning signals can describe characteristics such as the brightness and turning-on sequence, etc., of a row of micro-LEDs. The corresponding scanning signals of a row of micro-LEDs are transmitted by a group of SFx (sf0-sf9) signal lines, and N rows correspond to N*10 signal lines.

During the row scanning process, one bit of data is transmitted in the form of a pulse signal on each sf signal line in a specific sequence. The pulse signals transmitted on the sf signal lines have corresponding pulse lengths, and the pulse length of the pulse signal transmitted on each sf signal line=pulse unit length*brightness level.

The brightness level refers to the number of adjustable different levels for measuring the brightness of a light-emitting device (e.g., a micro-display panel), for example, a brightness level is 8 level, which means that the brightness of the device can be adjusted in 8 different gears, the more levels, the more precise the brightness adjustment can be achieved.

In many application scenarios where brightness is controlled through pulse width modulation (PWM), the brightness level is typically achieved by changing the duty cycle. Under normal circumstances, the higher the duty cycle, the higher the corresponding brightness level, and the stronger the brightness exhibited by the light-emitting device. For example, when the duty cycle increases from 10% to 50%, all other conditions being equal, the brightness will increase accordingly, which means that the brightness level will change towards brighter gears. This is because the larger the duty cycle, the greater proportion of time the device is powered on and emits light within a unit time interval, and the more luminous flux the human eye receives, the brighter it feels.

TABLE 1
illustrates the pulse unit length for the sf0-sf9 signal lines.

| Signal Line Name | Pulse Unit Length |
|---|---|
| sf0 | 1 |
| sf1 | 2 |
| sf2 | 4 |
| sf3 | 8 |
| sf4 | 16 |
| sf5 | 32 |
| sf6 | 64 |
| sf7 | 128 |
| sf8 | 256 |
| sf9 | 512 |
| Total Pulse Unit Length | 1023 |

As shown in the table, the pulse unit length increases sequentially from sf0 to sf9. In the case of the brightness level unchanged, the greater the pulse unit length, the greater the pulse length of the sf signal line, therefore, the pulse length progressively increases from sf0 to sf9, and the pulse length of sf0 is smallest, and the pulse length of sf9 is greatest. The law of progressively increasing pulse length can be used as a basis for identification, and the receiving end can more orderly and accurately receive each bit of data in sequence according to this characteristic of the pulse length gradually increasing in sequence, so that the complexity of data processing and the possibility of errors are reduced.

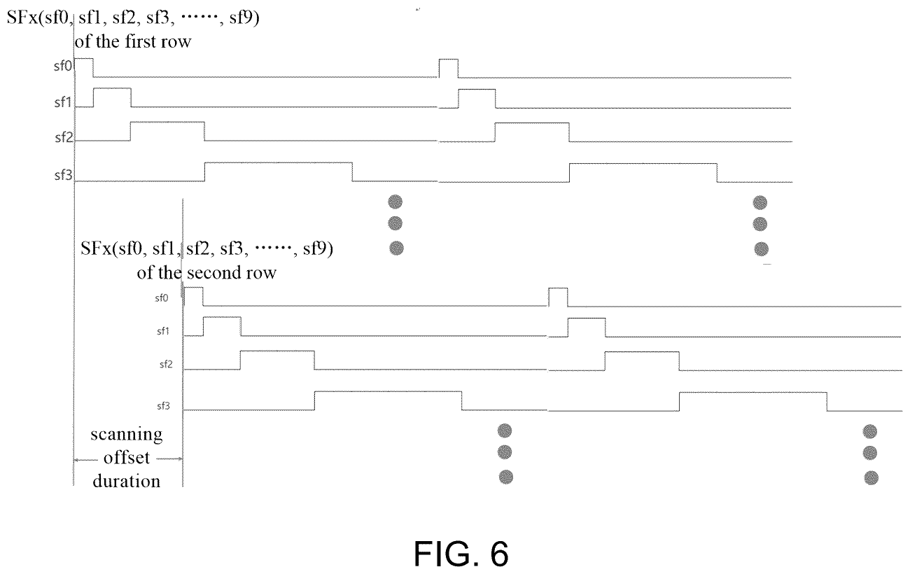

FIG. 6 illustrates a timing schematic diagram of a global scanning method with offset according to an embodiment of the present disclosure.

The first to fourth rows in FIG. 6 illustrate the transmission of pulse signals on the four signal lines of the first display group. The first display group includes a row of micro-LEDs. At the beginning of the scanning period, the corresponding scan signal of the first display group controls the sf0 signal line to become a high voltage level, and a pulse signal is transmitted on it, and the remaining signal lines become low voltage level. The scanning start time point for the first display group is the time point when the sf0 signal line becomes high voltage level. After the first pulse duration, the sf0 signal line becomes a low voltage level, meanwhile, the sf1 signal line becomes a high voltage level, and a pulse signal is transmitted on it, and the remaining signal lines become low voltage level. After the second pulse duration, the sf1 signal line becomes a low voltage level, meanwhile, the sf2 signal line becomes a high voltage level, and a pulse signal is transmitted on it, and the remaining signal lines become low voltage level. After the third pulse duration, the sf2 signal line becomes a low voltage level, meanwhile, the sf3 signal line becomes a high voltage level, and a pulse signal is transmitted on it, and the remaining signal lines become low voltage level. And so on, until the sf9 signal line becomes a low voltage level, the scanning for the first display group is completed.

The fifth to eighth rows in FIG. 6 illustrate the signal pulse lengths on the four signal lines for the second display group. The second display group includes a row of micro-LEDs. The corresponding scan signal of the first display group controls the sf0 signal line to become a high voltage level, and a pulse signal is transmitted on it, and the remaining signal lines become low voltage level. After the first signal pulse duration, the sf0 signal line becomes a low voltage level, meanwhile, the sf1 signal line becomes a high voltage level, and a pulse signal is transmitted on it, and the remaining signal lines become low voltage level. After the second signal pulse duration, the sf1 signal line becomes a low voltage level, meanwhile, the sf2 signal line becomes a high voltage level, and a pulse signal is transmitted on it, and the remaining signal lines become low voltage level. After the third signal pulse duration, the sf2 signal line becomes a low voltage level, meanwhile, the sf3 signal line becomes a high voltage level, and a pulse signal is transmitted on it, and the remaining signal lines become low voltage level. When the sf3 signal line becomes a low voltage level, it indicates that the scanning for the first display group is completed. The scanning start time point for the first display group is the time point when the sf0 signal line becomes high voltage level.

The scanning start time for the second display group is the time point when the sf0 signal line becomes high voltage level. The scanning offset duration between the second display group and the first display group is the interval between the time point when the sf0 signal line of the second display group becomes high voltage level and the time point when the sf0 signal line of the first display group becomes high voltage level.

And so on, until the display of a frame of image is completed. Overall, each scanning signal alternates in sequence to become a high voltage level to scan all display groups one by one, and the scanning of all display groups is completed within a complete scanning period, which repeats continuously, and combined with the visual persistence effect of the human eye, it allows the observer to see a complete and stable image display.

When a display group includes two rows of micro-LEDs, the two rows of micro-LEDs are controlled by a group of scanning signals. This group of scanning signals includes two sub-signal groups, totaling 20 bits of data. Each row of micro-LEDs corresponds to a sub-signal group including 10 bits of data. During scanning, these two rows of micro-LEDs are scanned simultaneously, and the corresponding two sub-signal groups of the two rows of micro-LEDs are transmitted simultaneously, and the transmission method of 10 data in each sub-signal group is the same as that when a display group includes only one row of micro-LEDs.

When a display group includes three rows of micro-LEDs, the three rows are controlled by a group of scanning signals. This group of scanning signals includes three sub-signal groups, totaling 30 bits of data. Each row of micro-LEDs corresponds to a sub-signal group including 10 bits of data, and so on.

By using the global scanning method with offset of the present disclosure to scan the micro-LEDs of a micro-display panel, multiple rows of micro-LEDs are divided into a plurality of display groups, these groups are scanned in an offset manner, and each display group has a different scanning start time, the number of micro-LEDs turned on at the same time can be reduced, and the distribution of current is more uniform in time and space, thus local concentration of peak current is avoided, and the voltage drop generated during scanning is reduced, so that the service life of the micro-display panel can be improved and the stability of the display system is improved.

Due to differences in the luminous characteristics of different micro-LEDs (red, green, blue), such as response time and luminous efficiency, etc., are different, when using a full-screen turning-on scanning method, it may result in uneven color mixing due to LEDs of different colors being turned on at different times, and a plurality of micro-display panels are scanned using a global scanning method with offset, which is more conducive to mixing of different colors and reducing color separation phenomenon.

During scanning, there is an interval between the transmission start time points of two bits of data adjacent in transmission times in the multi-bit data corresponding to each row of micro-LEDs, and data transmission for the next bit begins only after the transmission of the previous data is completed, the current generated at the same time is small, and the voltage drop generated during the scanning process is reduced, which can improve the service life of the micro display panel. A plurality of micro-display panels use this transmission method for scanning signals, which is more conducive to mixing of different colors and reducing color separation phenomenon.

The disclosure also provides a micro-display system, which includes: one or more micro-display panels; and a controller configured to execute the aforementioned global scanning method with offset.

In one embodiment, the controller may be a register, a central processing unit (CPU), etc.

In some embodiments, the micro-display panel includes a micro-LED chip configured to emit light; and a circuit board electrically connected with the micro-LED chip.

In some embodiments, the circuit board may include a flexible circuit board and/or a rigid circuit board. The circuit board has an external interface, and the external interface is configured to connect to an external power source and/or control commands to power the micro-LED chip and/or control the micro-LED chip.

In some embodiments, the micro-LED chip includes a drive backplane; and a plurality of micro-LEDs arranged in an array on the drive backplane.

In some embodiments, the size of each micro-LED chip does not exceed 1 centimeter, preferably not exceeding 20 micrometers. The micro-LED structures are formed in the form of an array in the micro-LED chip, and with resolutions such as 720*480, 640*480, 1920*1080, 1280*720, 2K, or 4K. The diameters of the micro-LED structures are in the nanometer-level, for example, 20 nm to 100 nm.

In some embodiments, the micro-LED array may include a single layer of micro-LED structures. In some embodiments of the present disclosure, the pitch of the micro-LED array, i.e., the minimum center-to-center distance between micro-LEDs, may be between approximately 2 micrometers and approximately 50 micrometers. In some embodiments, the number of pixels on the micro-LED chip may be between thousands to millions.

In some embodiments, the micro-LEDs may be arranged in a regular or irregular manner on the drive backplane as pixels of the micro-LED chip.

In some embodiments, the drive backplane may be electrically connected with each micro-LED in the micro-LED array through individual metal interconnections. In some embodiments, each micro-LED may be individually electrically controlled by the drive backplane. In some embodiments, the drive backplane may be electrically connected with electrodes of the micro-LED chip through metal interconnections. In some embodiments, the drive backplane is an IC backplane.

In some embodiments, the drive backplane includes a substrate, a drive circuit, and drive electrodes. The drive circuit is located in the substrate and controls the turning-on and -off of the micro-LEDs; the drive electrodes are located in the substrate with at least the upper surfaces exposed, and the drive electrodes are electrically connected with the drive circuit. Each micro-LED corresponds to a drive electrode, and the micro-LEDs are located on the drive electrodes and electrically connected with the drive electrodes.

In some embodiments, the material of the drive electrodes is an alloy of one or more of the following metals: Ni, Al, Ti, Cu, Pt, and Au. In some embodiments, the substrate is a Si substrate. In other embodiments, the substrate is a transparent substrate, such as a glass substrate. Other substrate examples include GaAs, GaP, InP, SiC, ZnO, and sapphire substrates. In some embodiments, the substrate is approximately 700 micrometers thick. The drive circuit forms individual pixel drivers to control the operation of each individual pixel LED device. The drive circuit may, for example, include complementary metal oxide semiconductor (CMOS) devices or thin-film transistor (TFT) devices. In some embodiments, a dielectric layer may be formed in the gaps between the micro-LEDs. In some embodiments, the dielectric layer may also be formed in the gaps between interconnections.

The drive method of the micro-LEDs is, for example, a passive matrix (PM) drive, and the cathodes of all micro-LEDs of each array are connected together to a cathode line NL, while micro-LEDs of the same number of each array are connected to corresponding anode lines PL, respectively. Thus, the on/off and brightness of each LED can be individually controlled by controlling the signal on the corresponding cathode and anode.

In some embodiments, the micro-LEDs may be bonded to the surface of the drive backplane through a bonding layer. The drive electrodes are electrically connected with the bonding layer, and the bonding layer includes a first metal layer and a second metal layer. In some embodiments, the material of the first metal layer is an alloy of one or more of the following metals: Cr, Al, Ti, Ni, Pt, Au, and Sn; and/or the material of the second metal layer is an alloy of one or more of the following metals: Cr, Al, Ti, Ni, Pt, Au, and Sn.

In some embodiments, the micro-LED includes: an epitaxial layer, an ohmic contact layer, a passivation isolation layer, and a top conductive layer.

For convenience, “upward” is used to indicate away from the drive backplane, “downward” indicates facing the drive backplane, and other directional terms such as top, bottom, above, below, directly below, underneath, etc., are also explained accordingly.

In some embodiments, the micro-LED includes: an epitaxial layer, an ohmic contact layer, a top conductive layer, and a passivation isolation layer. The ohmic contact layer is located on the bonding layer and is electrically connected with the bonding layer. The epitaxial layer is arranged on the ohmic contact layer. The passivation isolation layer at least partially covers the side surface of the epitaxial layer, and the passivation isolation layer is located between the epitaxial layer and the top conductive layer. The top conductive layer is located on the side surface and top surface of the epitaxial layer.

In some embodiments, the material of the passivation isolation layer is, for example, a solid inorganic material or a plastic material. In some embodiments, the solid inorganic material includes silicon dioxide (SiO₂), aluminum oxide (Al₂O₃), silicon nitride (Si₃N₄), silicon carbide nitride (SiCN), hafnium oxide (HfO₂), tantalum pentoxide (Ta₂O₅), titanium dioxide (TiO₂), zirconium oxide (ZrO₂), lanthanum oxide (La₂O₃), magnesium oxide (MgO), phosphosilicate glass (PSG), boron phosphosilicate glass (BPSG), or any combination thereof. In some embodiments, the plastic material includes polymers such as SU-8, PermiNex, or benzocyclobutene (BCB), or transparent plastics (resins) including spin-on glass (SOG), or adhesive micro resist BCL-1200, or any combination thereof. The passivation isolation layer is transparent to light emitted from the epitaxial layer.

In some embodiments, the first metal layer of the bonding layer directly contacts the ohmic contact layer at the bottom of the epitaxial layer, and the second metal layer is located at the bottom layer of the bonding layer and away from the epitaxial layer, and the contour of the first metal layer is less than the contour of the second metal layer.

In some embodiments, the transverse dimension at the bottom of the epitaxial layer is greater than the transverse dimension at the top. In some embodiments, the epitaxial layer is a step shape or a trapezoid shape.

In some embodiments, the epitaxial layer is a trapezoid shape, but not limited to a normally arranged trapezoid or an upside-down arranged trapezoid. In some embodiments, the range of the inclination angle of the sidewall of the epitaxial layer is 60° to 85°. In one embodiment, the transverse dimension of the bonding layer is greater than the transverse dimension of the bottom of the epitaxial layer.

In some embodiments, the epitaxial layer includes a first type epitaxial layer, a second type epitaxial layer, and a light-emitting layer positioned between them. The first type epitaxial layer is located above the light-emitting layer, away from the drive backplane, while the second type epitaxial layer is positioned below the light-emitting layer, close to the drive backplane.

In some embodiments, the light-emitting layer is formed by multiple stacked quantum well layers, particularly superlattice-stacked quantum well layers. Preferably, the superlattice-stacked quantum well layers include multiple pairs of quantum well layers stacked with quantum barrier layers.

In one embodiment, the light-emitting layer includes a multi-quantum-well layer and an electron blocking layer, and the multi-quantum-well layer is an InGaN/GaN multi-quantum-well layer or an InGaN/AlGaN multi-quantum-well layer or an InGaAs/AlGaAs multi-quantum-well layer. In another embodiment, the first type epitaxial layer may also be a P-type GaN layer or a P-type AlGaN layer, while the second type epitaxial layer is an N-type GaN layer or an N-type AlGaN layer.

In some embodiments, the first type epitaxial layer is a semiconductor material with a first type epitaxial layer and includes a plurality of semiconductor layers. The primary matrix material of the first type epitaxial layer may be, but is not limited to at least two or more elements of Ga, N, As, P, In, and Al. Furthermore, the first type epitaxial layer may include, from top to bottom, but is not limited to, a confinement layer and a waveguide layer; furthermore, in some embodiments, an ohmic contact layer may be formed on the confinement layer.

In some embodiments, the second type epitaxial layer is a semiconductor material with a second conductivity type and includes a plurality of semiconductor layers. The primary matrix material of the second type epitaxial layer may be, but is not limited to, materials such as Ga, N, As, P, In, or Al, etc. Furthermore, the second type epitaxial layer may include, from top to bottom, but is not limited to, a waveguide layer, a confinement layer, a transition layer, and a window layer; furthermore, an ohmic contact layer may be formed below the window layer.

In some embodiments, the first type epitaxial layer is an N-type GaN layer or an N-type AlGaN layer, and the second type epitaxial layer is a P-type GaN layer or a P-type AlGaN layer, i.e., the material of the second type epitaxial layer is a material layer of a second conductivity type including at least two or more elements of Ga, N, As, Al, In, and P, and the first type epitaxial layer is a material layer of a first conductivity type including at least two or more elements of Ga, N, As, Al, In, and P.

In some embodiments, the light-emitting layer includes at least one quantum well layer. The thickness of the quantum well layer is between 20 nm and 40 nm, for example, the thickness is 30 nm. In some embodiments, the material of the quantum well layer is GaInP/(AlₓGa₁₋ₓ)_{y}In_{1-y}P, and the range of x is 0.5 to 0.9, and the range of y is 0.3 to 0.5. For example, x is 0.8 and y is 0.5. In some embodiments, the relationship between x and y is that x is 1 to 2 times y. In some embodiments, the light-emitting layer is a multi-quantum well (MQW).

In some embodiments, one of the first type epitaxial layer and the second type epitaxial layer is an N-type semiconductor layer, and the other is a P-type semiconductor layer. In some embodiments, the N-type semiconductor layer also includes a doped N-type contact layer and an N-type cladding layer. The N-type cladding layer is formed on the doped N-type contact layer. The material of the N-type cladding layer is AlₓIn₁₋ₓP, and the range of x is 0.1 to 0.5, for example, x is 0.5. Furthermore, in these embodiments, the thickness of the N-type cladding layer is no greater than 350 nm, for example, the thickness of the N-type cladding layer is 320 nm. The doping concentration of the N-type cladding layer is 5e¹⁷ cm⁻³ to 1e¹⁸ cm⁻³. In some embodiments, the N-type semiconductor layer also includes a doped N-type contact layer and an N-type cladding layer formed on the doped N-type contact layer. The material of the doped N-type contact layer is GaAs. In some embodiments, the thickness of the doped N-type contact layer is 10 nm to 30 nm. In some embodiments, the doping concentration of the doped N-type contact layer is 2e¹⁸ cm⁻³ to 1e¹⁹ cm⁻³. In some embodiments, the N-type semiconductor layer also includes an N-type spacer layer formed on the N-type cladding layer. The material of the N-type spacer layer is (AlₓGa₁₋ₓ)_{y}In_{1-y}P, and the range of x is 0.5 to 0.9, and the range of y is 0.1 to 0.5. For example, x is 0.8 and y is 0.5. In some embodiments, the relationship between x and y is that x is 1 to 2 times y. The thickness of the N-type spacer layer is 50 nm to 75 nm, for example 65 nm. In some embodiments, the P-type semiconductor layer includes a P-type cladding layer and a doped P-type contact layer. The P-type cladding layer is formed on the light-emitting layer, and the doped P-type contact layer is formed on the P-type cladding layer.

In some embodiments, the material of the P-type cladding layer is AlₓIn₁₋ₓP, and x is 0.3 to 0.5, for example, x is 0.5. In such embodiments, the thickness of the P-type cladding layer is no greater than 380 nm, for example, the thickness of the P-type cladding layer is 360 nm.

In some embodiments, the material of the doped P-type contact layer is GaAs. The thickness of the doped P-type contact layer is 10 nm to 30 nm, for example 20 nm.

In some embodiments, the P-type semiconductor layer also includes a P-type spacer layer formed below the P-type cladding layer, a first doped P-type transition layer formed on the P-type cladding layer, and a second doped P-type transition layer formed on the first doped P-type transition layer. In some embodiments, the material of the P-type spacer layer is (AlₓGa₁₋ₓ)_{y}In_{1-y}P, and the range of x is 0.5 to 0.9, and the range of y is 0.3 to 0.5. For example, x is 0.8 and y is 0.5. In some embodiments, the relationship between x and y is that x is 1 to 2 times y. In some embodiments, the thickness of the P-type spacer layer is 50 nm to 75 nm, for example 65 nm.

In some embodiments, the material of the first doped P-type transition layer is (AlₓGa₁₋ₓ)_{y}In_{1-y}P, and the range of x is 0.1 to 0.3, and the range of y is 0.3 to 0.5. For example, x is 0.17 and y is 0.5. In some embodiments, the relationship between x and y is that y is 1 to 5 times x. In some implementations, the thickness of the first doped P-type transition layer is 20 nm to 40 nm, for example 30 nm.

In some embodiments, the material of the second doped P-type transition layer is AlₓGa₁₋ₓAs, and the range of x is 0.5 to 0.9, for example x is 0.6. In some embodiments, the thickness of the second doped P-type transition layer is 10 nm to 30 nm, for example 20 nm.

In some embodiments, the doping concentration of the second doped P-type transition layer is greater than the doping concentration of the first doped P-type transition layer. The doping concentration of the doped P-type contact layer is 1 to 10 times the doping concentration of the second doped P-type transition layer.

In some embodiments, the doping concentration of the doped P-type contact layer is greater than the doping concentration of the second doped P-type transition layer. Furthermore, in some embodiments, the doping concentration of the second doped P-type transition layer is 2 to 4 times the doping concentration of the first doped P-type transition layer.

For example, the doping concentration of the first doped P-type transition layer is greater than 1e¹⁸ cm⁻³, the doping concentration of the second doped P-type transition layer is in the range of 2e¹⁸ cm⁻³ to 4e¹⁸ cm⁻³, and the doping concentration of the doped P-type contact layer is greater than 5e¹¹ cm⁻³. In some embodiments, the electrode polarity of the ohmic contact layer is opposite to the electrode polarity of the top conductive layer, the ohmic contact layer may be, for example, a P electrode or an anode electrode, and the top conductive layer is an electrode with opposite polarity to the ohmic contact layer, for example, an N electrode or a cathode electrode. In one embodiment, the ohmic contact layer, the top conductive layer, and their connecting components may be a combination of one or more of, such as graphene, or indium tin oxide (ITO), or aluminum-doped zinc oxide (AZO), or fluorine-doped tin oxide (FTO), or other transparent conductive oxides (TCOs).

In one embodiment, adjacent top conductive layers are connected, and all top conductive layers are connected as a whole. In some embodiments, the top conductive layer may be shared by all micro-LEDs in a micro-LED array.

In some embodiments, the electrode polarity of the ohmic contact layer is opposite to the electrode polarity of the top conductive layer, the ohmic contact layer may be, for example, a P electrode or an anode electrode, and the top conductive layer is an electrode with opposite polarity to the ohmic contact layer, for example, an N electrode or a cathode electrode. In one embodiment, the ohmic contact layer, the top conductive layer, and their connecting components may be a combination of one or more of, such as graphene, or indium tin oxide (ITO), or aluminum-doped zinc oxide (AZO), or fluorine-doped tin oxide (FTO), or other transparent conductive oxides (TCOs).

In some embodiments, adjacent passivation isolation layers are connected, and all passivation isolation layers are connected as a whole. In one embodiment, the material of the passivation isolation layer is one or more of silicon oxide, silicon oxynitride, aluminum oxide, and silicon nitride.

In some embodiments, the micro-LED chip further includes a current expansion structure located between the micro-LEDs, and the current expansion structure is arranged to surround the micro-LEDs, and the current expansion structure is configured to electrically contact the micro-LEDs and at least partially reflect light emitted by the micro-LEDs.

The current expansion structure surrounds the micro-LEDs, and the current expansion structure is electrically connected with the micro-LEDs.

The surface of the current expansion structure facing the micro-LEDs has light reflection ability. For example, it is made of metal, so that the current expansion structure can at least partially reflect the light emitted by the LED. The reflection process is that: the light emitted from the light-emitting layer of the LED passes through the transparent layer (e.g., the top conductive layer) above it, and then a first part of this light (whose exit angle is small enough not to touch the current expansion structure on the side surface, within a preset exit angle, such as ±20°) directly exits, the second part of this light (whose exit angle is large enough to touch the current expansion structure on the side surface) touches the current expansion structure and is reflected, and then exits with a changed optical path direction within the preset exit angle, thereby effectively improving the light extraction efficiency. Preferably, the proportion of light reflected by the current expansion structure to the light emitted by the LED can be, for example, 10% to 60%. By arranging a current expansion structure with light reflection ability, the amount of light absorbed by the sidewall can be significantly reduced, thereby significantly increasing the total light output. Meanwhile, the current expansion structure can also isolate light and prevent light crosstalk between adjacent LEDs.

By arranging the current expansion structure to surround the top conductive layer of the micro-LED in an electrical contact manner, the electrical contact area between the current expansion structure and the micro-LED can be significantly increased, thereby enabling the active layer (light-emitting layer) of the micro-LED to emit light more uniformly, so that high brightness of light emission only at the electrical contact area or near the electrical contact area is effectively avoided.

The bottom dimensions of the current expansion structure are larger than its top dimensions. Since the bottoms of adjacent current expansion structures are connected, the longitudinal cross-section of two adjacent current expansion structures exhibits a bifurcated peak shape.

The bottoms of adjacent current expansion structures are connected, and all current expansion structures are connected as a whole. For the micro-LED with a circular top view shape (i.e. cross-sectional shape), the top view shape of the overall current expansion structure is the remaining grid shape after removing the circular shape. In other embodiments, the top view shape of the micro-LED may also be other appropriate shapes, such as rectangle, square, or regular polygon, etc. The top view shape of the overall current expansion structure may also be the shape remaining after removing other appropriate shapes, such as the remaining grid shape after removing rectangles, squares, or polygons.

In embodiments of the present disclosure, the bottom of the current expansion structure is lower than the epitaxial layer of the micro-LED.

In embodiments of the present disclosure, the top of the current expansion structure may be higher than the top of the epitaxial layer; the top of the current expansion structure may also be flush with the top of the epitaxial layer; the top of the current expansion structure may also be lower than the top of the epitaxial layer (e.g., slightly lower than the top of the epitaxial layer by 0-1 micrometers). One, two, or three of the above situations may coexist in a chip.

Preferably, the top of the current expansion structure is higher than the top of the epitaxial layer of the micro-LED, and by making the height of the top of the current expansion structure greater than the height of the top plane of the epitaxial layer of the micro-LED, a higher current expansion structure can be achieved, and the opportunity of light reflection is further improved and the light extraction efficiency is increased.

In other embodiments, the number of current expansion structures may also be ¼ or 1/9 of the number of micro-LEDs, and each current expansion structure surrounds 4 micro-LEDs or 9 micro-LEDs, without limitation.

The current expansion structure can increase current expansion between adjacent micro-LEDs, and reduce resistance between adjacent micro-LEDs, and minimize losses. The current expansion structure can rapidly and uniformly expand current to all micro-LEDs.

In embodiments of the present disclosure, the current expansion structure may be a multi-layer structure, and the current expansion structure includes one or more main metal layers. In embodiments of the present disclosure, the material of the main metal layer may be one or more of Pt, Au, Al, or Ag.

In some embodiments, the current expansion structure may further include: isolation layers corresponding one-to-one with each main metal layer; and the isolation layers are arranged alternately with the main metal layers, and each main metal layer is located on a corresponding isolation layer.

By using isolation layers corresponding one-to-one with each main metal layer and arranging the isolation layers alternately with the main metal layers, and positioning each main metal layer on a corresponding isolation layer, the influence of electromigration within the current expansion structure can be effectively suppressed by arranging isolation layers, particularly in the case of high density of the micro-LEDs in micro-LED display chip, by arranging isolation layers, the possibility of increasing the height of the current spread structure is obtained, so that the light extraction efficiency is further improved through higher current expansion structure. Furthermore, the isolation layers may include titanium (Ti) metal layers. It should be noted that the materials of the isolation layers may also include other suitable materials, such as titanium nitride (TiN).

In some embodiments, the current expansion structure may further include: an adhesive layer located at the bottommost layer of the current expansion structure, and the isolation layers and main metal layers are located above the adhesive layer. The adhesive layer is formed between the micro-LEDs, and the isolation layers and main metal layers are located above the adhesive layer, the bottom stability of the current expansion structure can be effectively improved through the adhesive effect of the adhesive layer, particularly in the case of high density of the micro-LEDs in micro-LED display chip, by arranging the adhesive layer, the possibility of increasing the height of the current spread structure can be obtained, so that the light extraction efficiency is further improved through a higher current expansion structure. Furthermore, the adhesive layer may include a chromium (Cr) metal layer. It should be noted that the adhesive layer material may also include other suitable materials, such as one or more of the following: titanium (Ti), titanium nitride (TiN), or tungsten (W).

In embodiments of the present disclosure, the current expansion structure may further include: anti-diffusion layers corresponding one-to-one with the isolation layers, and each isolation layer is located above the corresponding anti-diffusion layer. By forming anti-diffusion layers corresponding one-to-one with the isolation layers, and locating each isolation layer above the corresponding anti-diffusion layer, the stability of the current expansion structure can be improved through the high hardness and excellent corrosion resistance characteristics of the anti-diffusion layers, particularly in the case of high density of the micro-LEDs in micro-LED display chip, by arranging anti-diffusion layers, the possibility of increasing the height of the current spread structure can be obtained, so that the light extraction efficiency is further improved through a higher current expansion structure. The anti-diffusion layers may include: platinum (Pt) metal layers, nickel (Ni) metal layers. It should be noted that the anti-diffusion layers may be a single-layer platinum metal layer, may also be a single-layer nickel metal layer, and may also be a stacked layer of single-layer platinum metal layer and single-layer nickel metal layer.

In some embodiments, the micro-LED chip further includes a micro-lens array. The micro-lens array is arranged above the micro-LED array, and at least one micro-lens is provided on the surface of the conductive layer at the top of the micro-LED, and the horizontal contour of the micro-lens is larger than the maximum horizontal contour of the micro-LED. The microlens primarily serves to converge and/or collimate light, for example, by adjusting parameters such as the thickness and curvature of the microlens, etc., the focal point of the microlens can be located in the epitaxial layer of the micro-LED. In some embodiments, microlenses in the microlens array correspond one-to-one with the epitaxial layers. In some embodiments, examples of microlenses include spherical microlenses, non-spherical microlenses, Fresnel microlenses, and cylindrical microlenses.

In embodiments of the present disclosure, adjacent microlenses have gaps between them. In embodiments of the present disclosure, the bottoms of the gaps are higher than the top of the epitaxial layer. In another embodiment of the present disclosure, the bottoms of the gaps are lower than the top of the epitaxial layer but higher than the bottom of the epitaxial layer. In yet another embodiment of the present disclosure, the bottoms of the gaps are located above the current expansion structure. Specifically, the gaps are located between two adjacent current expansion structures (i.e., between the bifurcation peaks).

Furthermore, the microlenses may also have air gaps inside. Each microlens may have a plurality of air gaps, and the size and length of each air gap is the same or different. Meanwhile, in the same chip, the number of air gaps and/or position and/or size of air gaps in different microlenses may be the same or different. In some embodiments of the present disclosure, the air gaps are located at the edge of the microlens, specifically, they may be located on two sides of the epitaxial layer, preferably, they are located between the epitaxial layer and the current expansion structure. Meanwhile, in some embodiments, the tops of the air gaps are higher than the top of the epitaxial layer, and the bottoms of the air gaps may be higher than the top of the epitaxial layer, and may also be lower than the top of the epitaxial layer. In some embodiments, the bottoms of the air gaps are higher than the top of the current expansion structure. In other embodiments, the bottoms of the air gaps are lower than the top of the current expansion structure. It should be noted that in other embodiments of the present disclosure, the microlenses may also not have an air gap inside.

In some embodiments, the micro-LED chip includes a light-emitting area and a non-light-emitting area, and the aforementioned micro-LEDs, current expansion structure, and microlens array are located in the light-emitting area. The non-light-emitting area surrounds the light-emitting area.

In some embodiments, the non-light-emitting area of the micro-LED chip has bonding wire electrodes, and the bonding wire electrodes are electrically connected with the drive backplane. The bonding wire electrodes are used for electrical connection with the circuit board outside the chip.

Although some embodiments of the present disclosure have been described in the present application, however, those skilled in the art will appreciate that these embodiments are merely illustrated as examples. Numerous variation schemes, alternative schemes, and improvement schemes may be conceived by those skilled in the art in light of the teachings of the present disclosure without departing from the scope of the present disclosure. The appended claims are intended to define the scope of the present disclosure and thus encompass methods and structures within the scope of these claims themselves and their equivalent variations.

What is claimed is:

1. A global scanning method with offset, comprising:
dividing multiple rows of micro-LEDs of at least one micro-display panel into a plurality of display groups, each of the plurality of display groups comprising one or more rows of micro-LEDs;
determining a scanning offset duration between display groups adjacent in terms of scanning time; and
scanning sequentially the plurality of display groups of the at least one micro-display panel according to the scanning offset duration.

2. The global scanning method with offset according to claim 1, wherein one or more rows of micro-LEDs scanned using the same group of scanning signals are divided into a display group.

3. The global scanning method with offset according to claim 1, wherein each display group comprises multiple rows of micro-LEDs, and the multiple rows of micro-LEDs are adjacent or not adjacent in positions.

4. The global scanning method with offset according to claim 1, wherein the scanning offset duration between display groups adjacent in terms of scanning time is determined according to a scanning period, a number of display groups, and a duty cycle of a frame of image data.

5. The global scanning method with offset according to claim 4, wherein the scanning period T, and the number of display groups M, the scanning offset duration t, and the duty cycle D of the frame of image data satisfy the following relationship:
$$T \geq ( D * T ) + t * ( M - 1 ) ,$$
wherein M is a positive integer, t, T, and D are positive numbers, and the scanning offset duration t and the duty cycle D are fixed values.

6. The scanning method with offset according to claim 5, wherein the larger the duty cycle, the greater the number of display groups, the smaller the maximum value of the scanning offset duration.

7. The global scanning method with offset according to claim 5, wherein the duty cycle D is less than 1.

8. The global scanning method with offset according to claim 1, wherein the scanning duration of each display group is the same.

9. The global scanning method with offset according to claim 1, wherein an interval between scanning start time points of two display groups adjacent in terms of scanning time equals the scanning offset duration.

10. The global scanning method with offset according to claim 1, wherein scanning sequentially the plurality of display groups of the at least one micro-display panel according to the scanning offset duration comprises:
first scanning a first display group, then scanning a second display group after a first scanning offset duration, and so on, scanning M-th display group after (M−1)-th scanning offset duration, wherein M is a number of the plurality of display groups, and M is a positive integer.

11. The global scanning method with offset according to claim 2, wherein a group of scanning signals comprises multiple bits of data.

12. The global scanning method with offset according to claim 11, wherein during scanning, a group of scanning signals is transmitted by a plurality of signal lines.

13. The global scanning method with offset according to claim 12, wherein each signal line transmits one bit of data.

14. The global scanning method with offset according to claim 13, wherein under a case that a display group comprises multiple rows of micro-LEDs, the group of scanning signals comprises a plurality of sub-signal groups, and each sub-signal group comprises multiple bits of data.

15. The global scanning method with offset according to claim 13, wherein under a case that a display group comprises one row of micro-LEDs, during scanning, an interval exists between transmission start time points of two bits of data adjacent in transmission times.

16. The global scanning method with offset according to claim 14, wherein under the case that a display group comprises multiple rows of micro-LEDs, during scanning, an interval exists between the transmission start time points of two bits of data adjacent in transmission times in each sub-signal group.

17. The global scanning method with offset according to claim 15, wherein the interval between the transmission start time points of two bits of data adjacent in transmission times equals a pulse length during the transmission of the previous bit of data.

18. The global scanning method with offset according to claim 17, wherein the pulse length of each bit of data increases sequentially.

19. The global scanning method with offset according to claim 10, wherein the at least one micro-display panel comprises a plurality of micro-display panels, each micro-display panel comprising a plurality of display groups.

20. A micro-display system, comprising:
one or more micro-display panels; and
a controller configured to execute the global scanning method with offset according to claim 1.
